(19) United States
(12) Patent Application Publication
(10) Pub. No.: US 2019/0248186 A1
(43) Pub. Date: Aug. 15, 2019

(54) POLYESTER CAP PLY

(71) Applicant: KORDSA TEKNIK TEKSTIL ANONIM SIRKETI, lzmit (TR)

(72) Inventor: Mehmet Sadettin FIDAN, Istanbul (TR)

(73) Assignee: KORDSA TEKNIK TEKSTIL ANONIM SIRKETI, Izmit (TR)

(21) Appl. No.: 15/739,780

(22) PCT Filed: Oct. 13, 2016
(86) PCT No.: PCT/TR2016/050381

§ 371 Date: Dec. 26, 2017

(51) Int. Cl. B60C 9/22

(52) U.S. Cl. CPC B60C 9/2204; B60C 2009/0092

(57) ABSTRACT

The present invention relates to a novel tire cord fabric or strip made of alternating parallel polyester (PET) cords having different twists. Such novel tire cord fabric or strips improve high speed durability, tread separation resistance and impact resistance when used as zero degree spirally wound cap ply in pneumatic radial tires.

### CROSS REFERENCE TO RELATED APPLICATIONS

This application is the national phase entry of International Application No. PCT/TR2016/050381, filed on Oct. 13, 2016, the entire contents of which are incorporated herein by reference.

### TECHNICAL FIELD OF THE INVENTION

The present invention relates to a novel tire cord fabric or strip comprising alternating parallel polyester cords having different twists. Such a novel tire cord fabrics or strips improve high speed durability, tread separation resistance and impact resistance when used as zero degree spirally wound cap ply on belt package in pneumatic radial tires.

### BACKGROUND OF THE INVENTION

Under high speed conditions, the outer diameter of the tire increases due to the centrifugal forces generated by steel cord belt package and tread. Such a diameter increase or tire growth increases the pantographic movements of the belt edge cords leading to the crack initiations, crack propagations and at the end belt edge separations. On the other hand, the temperature rise at belt edges under high speed conditions might cause local adhesion degradation of the textile cap ply strip and leads to local cap ply-tread separations which may subsequently result in belt edge separations in a short time due to non-uniform stress distributions.

The cap ply layer wound on belt package circumferentially prevents excessive tire growth under high speed conditions by applying compressive forces (restraining force) on heavy belt package made of cross-ply steel cord layers. In order to enhance the restraining force, high cord count (epdm) cap ply strips are usually used (e.g. PET 1100×2, 110 epdm etc.).

Currently, most widely used cap ply materials are nylon 6,6 and aramid/nylon hybrid cords, which are spirally wound on belt package at 0 to 5 degrees to equatorial plane of the tire.

PET (Polyethylene therephthalate) cords have higher modulus and higher in-tire cord tensions compared to nylon 6,6 cords as cap ply reinforcements. Due to less active sites (functional groups) on fiber surface compared to nylon 6,6; PET is more sensitive to thermal degradation of the adhesion with rubber at high temperatures. That's why, the tread-cap ply separation resistance of PET is less than nylon 6,6.

It is well known the hybrid cords comprising high and low modulus yarns having bi-elastic tensile behavior are also used as cap ply in high speed tires. The low modulus component of hybrid cord enables easy belt package lifting without excessive tight cord formation due to its high extensibility and the high modulus component becomes effective in service conditions. By using hybrid cords as cap ply, the total thickness of the cap ply layer and rubber content can be decreased, and the high modulus component of the hybrid cord enhances the restraining force and improves the high speed durability U.S. Pat. No. 7,584,774 describes a polyethylene terephthalate (PET) cord as belt reinforcing layer (cap ply) spirally wound on belt package in circumferential direction. Said PET cord has an elastic modulus not less than 2.5 mN/dtex. % under a load 29.4N at 160° C.

The major drawback with conventional PET cap plies in high speed radial tires, is the necessity of a robust dynamic adhesion to delay the crack formations between cords (due to shear forces). Under high speed conditions, temperature of belt edge area becomes higher, and modulus of PET cap ply cord goes down. That's why high epdm strips are preferred to use as single layer cap ply. But high epdm cap plies have a higher tendency for crack formations, which can lead to ply separations.

### SUMMARY OF THE INVENTION

The present invention relates to a novel tire cord fabric or strip made (woven) of alternating polyester cords having different twists. Such a novel tire cord fabrics or strips improve high speed durability, tread separation resistance and impact resistance when used as zero degree spirally wound cap ply in pneumatic radial tires.

Due to inferior dynamic adhesion of polyester (PET), it is preferred to be used as single layer, high epdm and narrow rivet cap ply on belt packages in high speed radial tires (FIG. 1).

On the other hand, the cord-to-cord distance (rivet area) in such fabrics or strips are too narrow which makes the rubber penetration difficult between the cords without scorch.

Additionally, the rubber cracks can easily initiate between the cords having narrow rivet under dynamic conditions due to high shear stresses.

According to the invention in the cap ply strips, the PET cords having different twists have different modulus or LASE, and different thermal shrink force values. During lifting (expansion) in the curing process, low twist PET cords (high modulus, low extensible cords) are loaded much higher than that of high twist cords (low modulus, high extensible cords). In addition to higher cord tensions, low twist nylon cords under higher loading generate higher thermal shrink force (contraction force) at curing temperature. As a result of higher cord loading and higher thermal shrink force, low twist nylon cords penetrate the skim compound more than high twist cords.

As a result of different penetration levels of low and high twist PET cords, the mono-ply cap strip layer becomes two layer cap strip (FIG. 2).

Definitions:

Cord: The reinforcement element formed by twisting together two or more plied yarns.

Denier: The gram weight of yarn having 9,000 meter length.

Dtex: The gram weight of yarn having 10,000 meter length.

Equatorial plane: Plane passing through the circumferential center line in tire

LASE: Load At Specified Load

7% LASE: Load At 7% Elongation in load elongation curve

Linear density: Weight per unit length as g/dtex or g/d (denier)

PET: Polyethylene terephthalate

Restraining force: Force applied by cap ply on belt package during driving to prevent tire growth

Total linear density: The sum of the nominal linear densities of the ply yarns of the cord

Two-ply cord: Cord prepared by twisting together two plied yarns

Three-ply cord: Cord prepared by twisting together three plied yarns

Twist: Number of turns per meter (t/m or tpm)

Warp: The set of yarn or cord in all woven fabrics, that runs lengthwise and parallel to the selvage and is interwoven with the filling.

### BRIEF DESCRIPTION OF THE DRAWINGS

FIG. 1 is a cross-sectional view of conventional (prior art) polyester (PET) cap ply on cross-ply steel cord belt package after curing process.

a is cross ply steel cord belt package

b is conventional cap ply on belt package

c is tread

FIG. 2 is a cross-sectional view of polyester (PET) cap ply according to the invention on cross-ply steel cord belt package after curing process.

a is cross ply steel cord belt package

b is cap ply on belt package according to invention

c is tread

FIG. 3A is a cross-sectional view of nylon cap ply according to invention on cross-ply steel cord belt package, (1) before curing process, (2) after curing process

A: First Polyester (PET) cord with higher twist or higher twist multiplier having lower modulus compared to B

B: Second Polyester (PET) cord with lower twist or lower twist multiplier having higher modulus compared to A

H: Cord penetration difference in rubber matrix.

FIG. 3B is a top view of PET cap ply strip made of A (higher twist, lower modulus, lower tension) and B (lower twist, higher modulus, higher tension) cords

FIG. 4A is a cross-sectional view of PET cap ply with side-by-side paired cords according to invention on cross-ply steel cord belt package, (1) before curing process, (2) after curing process

FIG. 4B is a top view of side-by-side (paired) A (higher twist, lower modulus, lower tension) and B (lower twist, higher modulus, higher tension) cords in cap ply strip

FIG. 5 shows the cord-to-cord distance changes after curing process

(1) before curing process, (2) after curing process

S1: Cord-to-cord distance between A and B before process expansion and curing.

S2: Cord-to-cord distance between A and B after process expansion and curing

S3: Cord-to-cord distance between A and A after process expansion and curing

S4: Cord-to-cord distance between B and B after process expansion and curing

FIG. 6 shows 1+2+1 cord arrangements.

(1)—A+B+B+A+B+B+A+ . . . cord arrangement before process expansion and curing

(2)—A+B÷B+A+B+B+A+ . . . cord arrangement after process expansion and curing

FIG. 7 shows 2+1+2 cord arrangements.

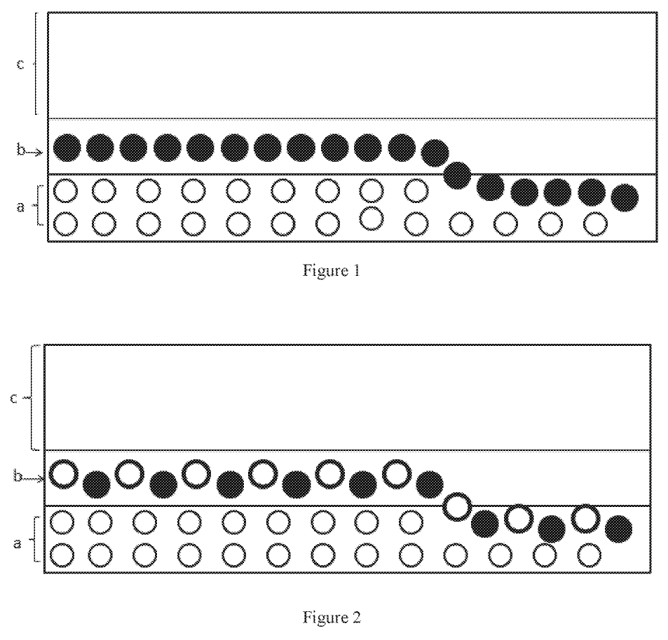

(1)—A+A+B+A+A+B+A+A+ . . . cord arrangement before process expansion and curing

(2)—A+A+B+A+A+B+A+A+ . . . cord arrangement after process expansion and curing

### DETAILED DESCRIPTION OF THE INVENTION

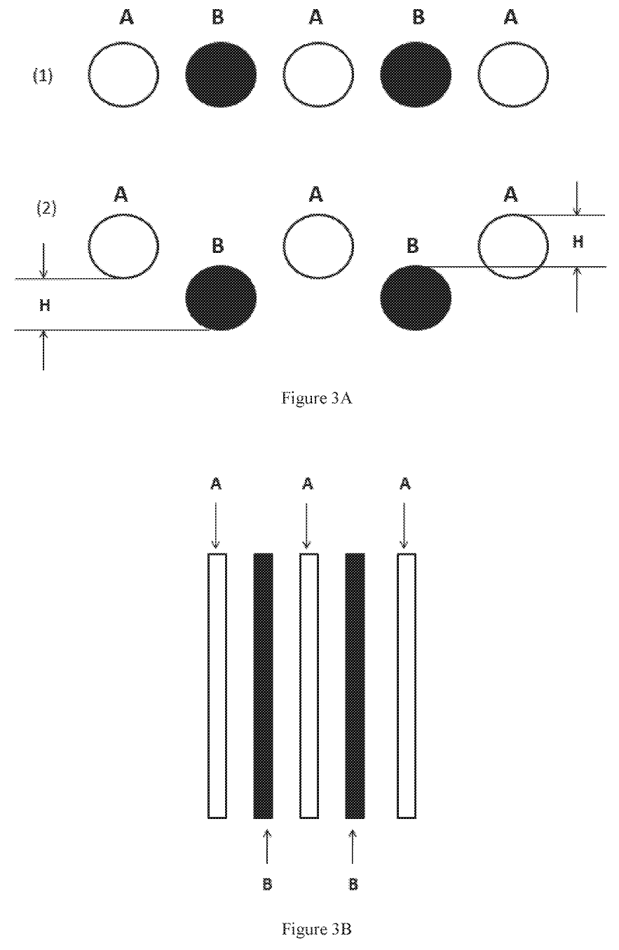

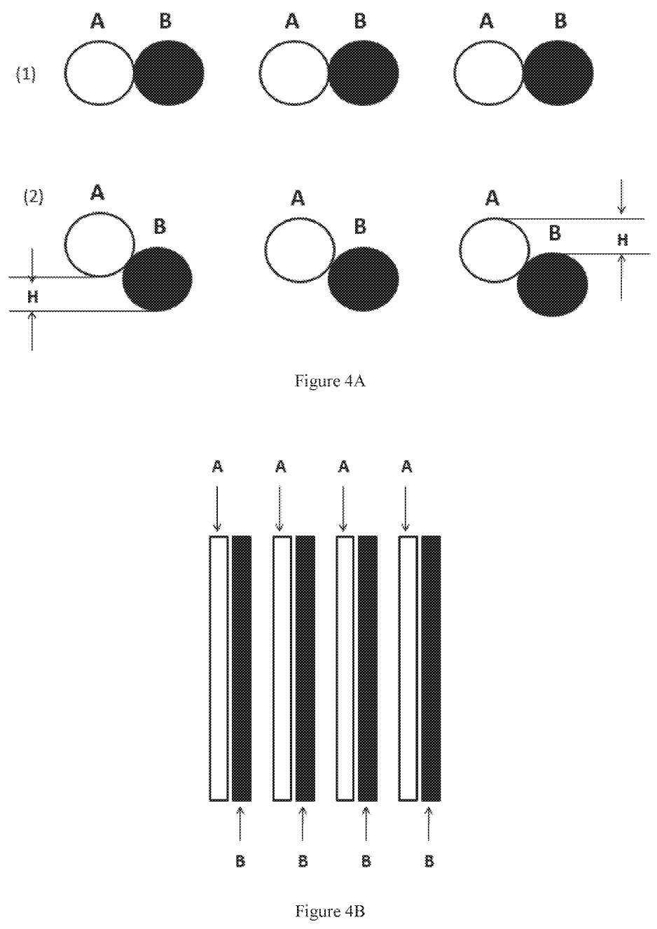

According to invention, the spirally wound cap ply fabrics or cap ply strips on belt package of the pneumatic radial tires in circumferential direction, having alternate polyester (PET) warp cords with different twist levels;
improves the high speed durability due to high modulus of low twist PET cords, and increased cord-to-cord distances (less shear stresses) between cords (cord shiftings in vertical direction, two layer or zig-zag formation), (FIGS. 3A, 3B and 5).
improves the impact resistance of belt package due to higher energy absorption of high twist, and high extensible PET cords
and also improves the tread-cap ply separation resistance due to the wavy surface structure of the cap ply. The zig-zag surface enhances mechanical bonding between. cap ply and tread compound.

The first PET cord (A) and second PET cord (B) in cap ply strip are two and/or three-ply cords.

The angle of spirally wound cap ply strips to circumferential center line (or equatorial plane of the tire) is 0 to 5°.

In order to obtain the advantages mentioned above, the twist factor of high twist PET cord (A) determined according to the formula (1) given below is at least 13,000 and less than 17,000.

Twist factor=Cord twist (tpm)×(total linear density of cord as dtex)½ (1)

According to invention, the twist factor of the second (lower twist) PET cord (B) is at least 15% and preferably 25% less than the twist factor of the first (high twist) PET cord (A).

If the twist factor of the second (lower twist) PET cord (B) is less than 15% of the twist factor of the first (higher twist) PET cord (A), the LASE, modulus or extensibility difference between them becomes insignificant. Under those conditions, the wavy cap ply surface can not be created in tire.

The total linear densities of the cords are minimum 1,000 dtex and maximum 5,000 dtex. The cap ply cords having less than 1,000 dtex are too thin and LASE values are too low which can not provide enough restraining force even with very high cord counts (epdm). Besides this drawback, during process lifting and curing, they can cut the skim compound of the belt layer and contact to steel cords. The cap ply cords having higher than 5,000 dtex are too thick and requires too much rubber for coating. The potential drawback for such cords in tire is increased rolling resistance and heat build-up in crown area.

The total linear density difference between the first PET cord (A) and the second PET cord (B) is less than 15%. Preferably, the total linear densities of the first PET cord (A) and the second PET cord should be the same.

According to the invention, the sequence of the first PET cord (A) and the second PET cord (B) is, parallel to each other in a cap ply strip is in an alternating form as A+B+A+B+A+B+ . . . and so on, wherein A is the first cord with higher twist, and B is the second cord with lower twist compared to A. Such a cap ply strip creates a uniform way surface after curing process, which bonds to tread compound strongly improving tread separation resistance under high speed conditions (FIG. 3A)

According to the invention, the sequence of the first PET cord (A) and the second PET cord (B) is parallel to each other in a cap ply strip is in an alternating form as AB+AB+AB+ . . . and so on, as paired cords, wherein A is the first cord with higher twist, and B is the second cord with lower twist compared to A (FIG. 4A).

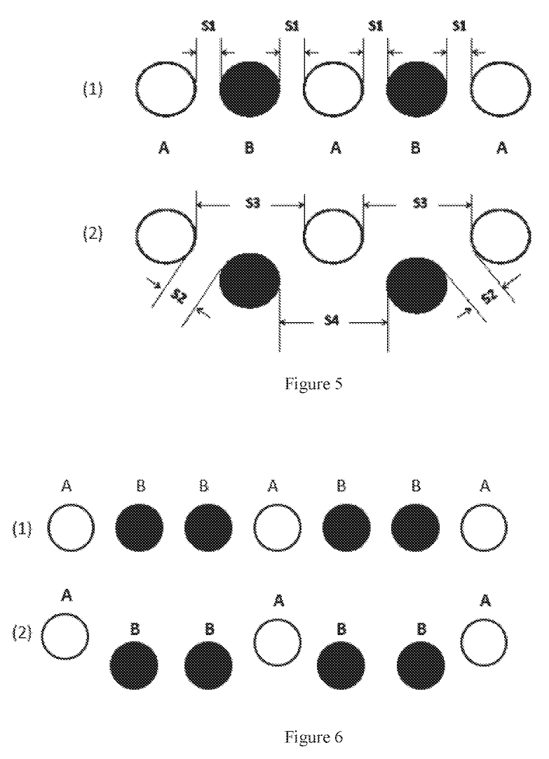

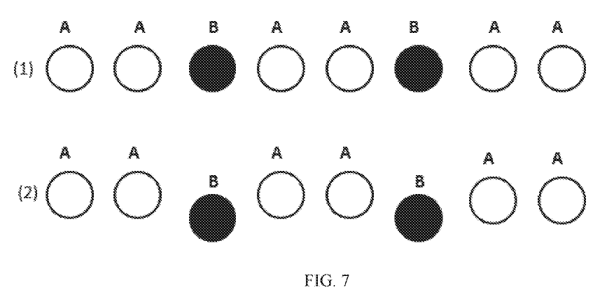

According to the invention, the sequence of the first PET cord (A) and the second PET cord (B) is parallel to each other in a cap ply strip is in an alternating form as A+B+B+A+B+B+A+B+B+ . . . and so on, wherein A is the first cord with higher twist, and B is the second cord with lower twist compared to A (FIG. 6).

According to the invention, the sequence of the first PET cord (A) and the second PET cord (B) is parallel to each other in a cap ply strip is in an alternating form as follows A+A+B+A+A+B+A+A+B+ . . . and so on, wherein A is the first cord with higher twist, and B is the second cord with lower twist compared to A (FIG. 7).

According to the invention, the cord count in strip is minimum 70 epdm (ends per decimeter). In case of cord counts lower than 70 epdm, the effectiveness of surface waviness is not enough for mechanical bonding to tread.

According to the invention, the width of the cap ply strips is 8 to 5 mm, preferably 10 to 15 mm.

1. A cap ply strip comprising:
a first polyethylene terephthalate (PET) cord and a second polyethylene terephthalate (PET) cord having a same linear density, wherein the first polyethylene terephthalate (PET) cord and the second polyethylene terephthalate (PET) cord are parallel alternately woven to make the cap ply strip;
wherein the first polyethylene terephthalate (PET) cord and the second polyethylene terephthalate (PET) cord are circumferentially wound on a belt package of a pneumatic radial tire;
wherein a twist factor of the first PET cord, determined according, to the following formula
Twist factor=Cord twist (tpm)×(total linear density of cord as dtex)½,
is at least 13,000 and less than 17,000; and
a twist factor of the second PET cord is at least 15% less than the twist factor of the first PET cord.

2. The cap ply strip according to claim 1, wherein the first PET cord and the second PET cord are two-ply cords.

3. The cap ply strip according to claim 1, wherein the first PET cord and the second PET cord are three-ply cords.

4. The cap ply strip according to claim 1, wherein the linear density of the first PET cord and the second PET cord ranges from 1,000 dtex to 500 dtex.

5. (canceled)

6. The cap ply strip according to claim 1, wherein the first and the second PET cords are arranged alternatively in said cap ply ship such that one first PET cord is followed by one second PET cord.

7. The cap ply strip according to claim 1, wherein the first and the second PET cords are repeated in pairs of one first PET cord and one second PET cord in said cap ply strip.

8. The cap ply strip according to claim 1, wherein the first and the second PET cords in said cap ply strip are arranged in a repeated pattern where one first PET cord is followed by two second PET cords.

9. The cap ply strip according to claim 1, wherein the first and the second PET cords in said cap ply strip are arranged in a repeated pattern where two first PET cords are followed by one second PET cord.

10. The cap ply strip according to claim 1, wherein a cord count in the cap ply strip is minimum 70 epdm (ends per decimeter).

11. The cap ply strip according to claim 1, wherein a width of the cap ply strip is minimum 8 mm and maximum 25 mm.

12. The cap ply strip according to claim 1, wherein a width of the cap ply strip is minimum 10 mm and maximum 15 mm.

13. The cap ply strip according to claim 1, wherein the twist factor of the second PET cord is 25% less than the twist factor of the first PET cord.

14. A cap ply strip comprising:
a first polyethylene terephthalate (PET) cord and a second polyethylene terephthalate (PET) cord having a same linear density;
wherein the first polyethylene terephthalate (PET) cord and the second polyethylene terephthalate (PET) cord are circumferentially wound on a belt package of a pneumatic radial tire;
wherein a twist factor of the first PET cord, determined according to the following formula
Twist factor=Cord twist (tpm)×(total linear density of cord as dtex)½,
is at least 13,000 and less than 17,000; and
a difference between the twist factor of the first PET cord and a twist factor of the second PET cord is less than 15%
